(19) United States
(12) Patent Application Publication
(10) Pub. No.: US 2011/0232696 A1
(43) Pub. Date: Sep. 29, 2011

(54) COMPACT RADIATOR-BASED HEAT EXCHANGER

(76) Inventors: GUILLERMO MORALES BARRIOS, NUEVO LEON (MX); HECTOR VALDEZ JARAMILLO, NUEVO LEON (MX); GERARDO ANGEL GONZALEZ CHAPA, NEUVO LEON (MX)

(21) Appl. No.: 12/730,066

(22) Filed: Mar. 23, 2010

(51) Int. Cl. B08B 3/02; F28F 1/10

(52) U.S. Cl. 134/105; 165/181

(57) ABSTRACT

The present invention generally relates to a compact heat exchanger for use in a mobile cleaning apparatus. The compact heat exchanger utilizes a water jacket, created by the annular space between a concentrically arranged internal housing and external housing. A radiator is enclosed within the internal housing. As super heated exhaust gas is supplied to the internal housing, heat is transferred to the surface of the internal housing before passing through the radiator. During operation of the mobile cleaning apparatus, incoming fluid, typically water, flows through an inlet and is directed through the water jacket and then the radiator for heating.

### FIELD OF THE INVENTION

The present invention is related to a new and beneficial compact heat exchanger to increase fluid temperature used in a cleaning apparatus. The compact heat exchanger increases the temperature of incoming fluid within a single housing and may most preferably be used as a device which pre-heats a cleaning fluid before that fluid is passed to a primary heater. In some applications, the heat exchanger may also be used as the primary heater of a cleaning fluid. When used in either embodiment, the heat exchanger reduces fuel costs associated with heating a cleaning fluid. The heat exchanger utilizes a water jacket created by the annular space between a concentrically arranged internal housing and external housing. Cleaning fluid enters and circulates within the water jacket, where it becomes preheated, before passing to a radiator. The radiator is enclosed within the internal housing and is used to further heat fluid flowing there through. In operation, heated gas is introduced into a chamber formed within the internal housing and before entering the radiator. That heated gas thereby comes in contact with and transfers heat to the internal housing. Thus, as an incoming cleaning fluid supply is directed into the water jacket, it is preheated by heat being transferred from the internal housing to the fluid before being directly further heated within the encircled radiator.

### BACKGROUND OF THE INVENTION

Cleaning devices are often used to clean items, such as motor vehicles or sidewalks. Such devices are usually mobile and are used at the site of the cleaning job. As is understood by those working in the art, cleaning fluids used in such devices typically consist of a mixture of heated water, steam, and/or a chemical solution that is delivered to an article to be cleaned by a cleaning wand assembly. While these are typical fluids, other fluids or combination of fluids, could certainly be used in a given environment. In any case, fluid supplied to the cleaning wand assembly often and preferably is heated substantially. That fluid temperature is to be maintained over a variety of operating conditions.

To heat fluid, prior art cleaning devices typically pass cleaning fluid through typical heat exchangers, causing heat applied to the exchangers (typically in the form of a heated gas) to pass from the gas to a medium (typically metal) to the fluid, resulting in heated fluid. The thermodynamic properties and functionality of heat exchangers, as well as the design and implementation of general purpose heat exchangers, is well within the knowledge of those working in this art. These artisans also understand that typically it is a heated gas which is placed in contact with the external surfaces of the heat exchanger, causing heat to transfer from the gas to the exchanger. Such gases can be super heated, such as exhaust gas exiting an internal combustion engine or gases developed for heating or merely heated gas, such as exhaust gas generated by vacuum pumps, etc.

As those working in the field understand, a number of prior art devices are directed to using available heat sources, namely, a combination of organic heat sources and various types of heat exchangers, to create both preheated and super heated cleaning fluid. For instance, U.S. Pat. No. 4,949,424 to Shero is such a system, whose disclosure is incorporated here by this reference. Shero utilizes two heat exchangers that first direct incoming fluid through the first heat exchanger, which heats the fluid to a temperature in the range of about 100 to 120° F. Next, the device directs the fluid through a second, gas-fired heat exchanger placed parallel to the first heat exchanger. The fluid is then heated to a temperature range of about 200 to 230° F. After the fluid is directed through both heat exchangers sequentially, a portion of the volume of the heated fluid is diverted back into the incoming fluid supply, causing a continuously circulating flow of somewhat heated fluid, raising incoming cold fluid temperatures. However, while the disclosed device certainly heats the incoming fluid, it does not utilize the radiator enclosed within a water jacket concept of the present invention and thus is not as efficient or compact as the system disclosed herein.

Similarly, U.S. Pat. No. 5,469,598 to Sales discloses a marginally more efficient system for heating and maintaining the heat of incoming fluids and is also incorporated into this disclosure by this reference. Sales also uses super heated exhaust gas from an internal combustion engine as the main source of heat which is supplied to a series of heat exchangers used to heat an incoming cleaning fluid. Two primary heat exchangers are again used in a parallel and sequential arrangement. A third heat exchanger is also used to preheat the fluid supply. The heat supplied to the third heat exchanger is from secondary sources, such as residual heat recovered from waste water, steam, and exhaust gas from a vacuum pump. As with the invention disclosed in Shero, Sales does not utilize the highly efficient radiator enclosed within a water jacket exchanger configuration of the present invention and thus does not use gaseous heat sources as efficiently as does the present invention or achieve desired fluid heating in a minimal amount of space.

Other prior art devices have utilized a concentric, or layered, arrangement of various heat exchanging devices to heat fluid. For instance, U.S. Pat. No. 4,023,558 to Lazardis utilizes a jacket having an inner wall and an outer wall. A fluid to be heated passes between these walls and is heated by the transfer of heat through the wall structure. A conduit bounded to the inner wall of the disclosed device conveys the hot gas towards the inner wall through a series of baffles that are placed longitudinally in sections parallel to the inner wall. The hot gas is directed through the baffles towards the inner wall, where water passing through the jacket can be heated. However, after the water is directed through the jacket, the water is not directed into the conduit for direct exposure to the hot gas and is thus inefficient. Nor is the disclosed device used in a mobile cleaning device context. Lazardis is also incorporated into this disclosure by this reference.

In U.S. Pat. No. 6,564,755 to Whelan, a water jacket is utilized to preheat a hot water system and is also incorporated into this reference. In particular, a heat exchanger surrounds a flue pipe from a furnace for preheating water. The heat exchanger includes an annular space that constitutes a sleeve, which surrounds the flue pipe to form a water jacket. Water storage tanks are connected in series and mounted around the sleeve to absorb heat from the water jacket. Water then flows through each water tank, absorbing heat which is then directed through the sleeve surrounding the flue pipe to be further heated. While this device does utilize a water jacket concept, that water jacket absorbs and transfers residual heat from the flue pipe. In other words, Whelan is a heat recovery device that uses secondary sources of heat to preheat an incoming water supply, and does not further heat a cleaning fluid with direct contact to a radiator. Whelan also does not utilize a direct source of heat, such as super heated exhaust gas from an internal combustion engine, to heat a cleaning fluid.

As described, prior art devices used in mobile cleaning systems may utilize multiple heat exchangers to directly heat an incoming fluid and/or recovered secondary gas sources to preheat an incoming fluid. These devices may also divert a portion of the heated fluid to preheat an incoming fluid. Other devices utilizing a water jacket-like mechanism to heat a fluid are not used in mobile cleaning systems. Within the context of cleaning devices, there is thus a need for a compact heat exchanger that efficiently preheat and/or heat an incoming cleaning fluid using both residual or secondary sources of heat and direct heat from the exhaust gases.

### SUMMARY OF THE INVENTION

It is an object of the present invention to provide a compact heat exchanger that utilizes available heat sources more efficiently and effectively to produce heated cleaning fluid than prior art devices. The compact heat exchanger acts as both a heat recovery device to either preheat an incoming fluid, or, in some embodiments, fully heat the fluid. It is a further object of the present invention to achieve a more compact heat exchanger than previously available, such that the size of the cleaning apparatus will be reduced. These and other advantages are achieved by the device of the present invention.

The present invention preferably includes a primary super heated exhaust gas generating means, such as exhaust from an internal combustion engine. The preferred device also includes an inlet for the supply of cleaning fluid into the device and outlet for heated cleaning fluid to exit the device. The present invention also preferably includes an internal housing that substantially encloses a heat exchanging device, such as a radiator. There is also an external housing that substantially surrounds the internal housing, such that a water jacket is created in the annular space between the internal and external housing. As heated exhaust gases or other appropriate gases flow into the internal housing, heat from the exhaust gas will be transferred to the internal housing. As fluid flows into the inlet, it will be directed through the water jacket to be heated by heat transferring from the gas to the internal housing and finally to the fluid. Subsequently, that fluid will flow directly from the water jacket into the radiator where a more direct heat transfer of the heated gas will be passed to the fluid.

The novel design of the compact heat exchanger disclosed herein may utilize organic direct heat sources to preheat or fully heat cleaning fluid within a single compact heat exchanger, rather than utilizing other secondary sources of heat. The novel design thus may heat incoming cleaning fluid more efficiently than previously accomplished and allows for a more compact mobile cleaning device which reduces overall fuel consumption of a cleaning apparatus into which it may be incorporated.

The Summary of the Invention is neither intended nor should it be construed as being representative of the full extent and scope of the present invention. The present invention is set forth in various levels of detail in the Summary of the Invention, as well as in the attached drawings and the Detailed Description of the invention. No limitation as to the scope of the present invention is intended by either the inclusion or non-inclusion of elements, components, etc., in the Summary of the Invention. Additional aspects of the present invention will become more readily apparent from the Detailed Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a schematic view of a cleaning apparatus in accordance with the present invention;

FIG. 2 is a view of one embodiment of the present invention;

FIG. 3 is a cross-sectional view of FIG. 2 of the present invention; and

FIG. 4 is a exploded view of FIG. 2 of the present invention.

To assist the reader in the understanding embodiments of the present invention, the following list of components and associated numbering found in the drawings is provided herein:

| Component # | Component Name |
|---|---|
| 10 | mobile cleaning apparatus |
| 20 | inlet |
| 22 | fluid box |
| 24 | pump |
| 30 | heat generating unit |
| 50 | wand assembly |
| 100 | compact heat exchanger |
| 105 | inlet pipe |
| 110 | exhaust gas inlet |
| 111 | openings |
| 120 | top cover |
| 130 | bottom cover |
| 140 | external housing |
| 150 | internal housing |
| 160 | ring |
| 170 | water jacket |
| 180 | primary heat exchanging device |
| 185 | radiator inlet |
| 186 | radiator outlet |
| 190 | intermediate pipe |
| 195 | conduit |
| 199 | exhaust pipe |
| 200 | second heat exchanger |

It should be understood that the drawings are not necessarily to scale. In certain instances, details that are not necessary for an understanding of the invention or that render other details difficult to perceive may have been omitted from these drawings. It should be understood, of course, that the invention is not limited to the particular embodiments illustrated in the drawings.

### DETAILED DESCRIPTION

As required, detailed embodiments of the present invention are disclosed herein. However, it is to be understood that the disclosed embodiments are merely exemplary of the invention, which may be embodied in various forms. Therefore, specific structural functional details provided herein are not to be interpreted as limiting, but merely as a basis for the claims and as a representative basis for teaching one skilled in the art to variously employ the present invention in virtually any appropriately detailed structure.

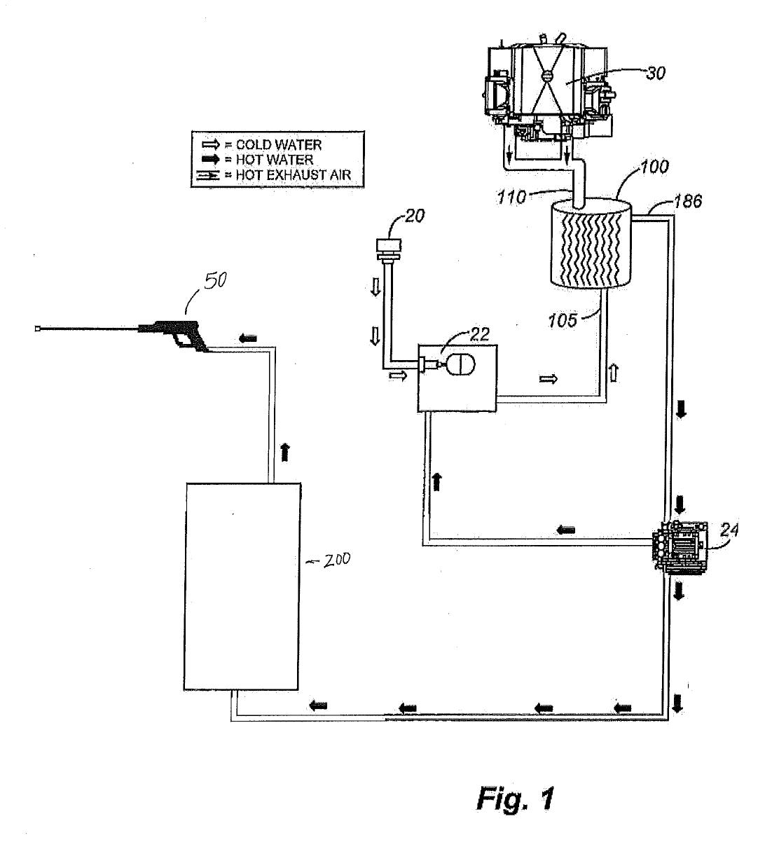

A mobile cleaning apparatus 10 of the present invention is shown in FIG. 1. An incoming fluid supply, typically water but which could be any cleaning fluid, for use in the apparatus 10 flows through inlet 20 to the fluid box 22, which is a storage apparatus for initially holding incoming cold fluid. A pump 24 moves fluid from the fluid box 22 throughout the system. A heat generating unit 30, such as an internal combustion engine, serves as the main source of super heated gas for use in heating fluid passing through the exchanger. Exhaust from vacuum pumps, etc. could be aggregated with these gases to increase overall gas temperature and/or volume. It should be understood that other heated gas sources could also be utilized with the invention.

A cleaning wand or tool (not shown) related to wand assembly 50 serves as the outlet for the heated fluid. It is understood by those skilled in the art that the wand assembly 50 could be replaced by any appropriate cleaning tool, such as a surface cleaner, etc.

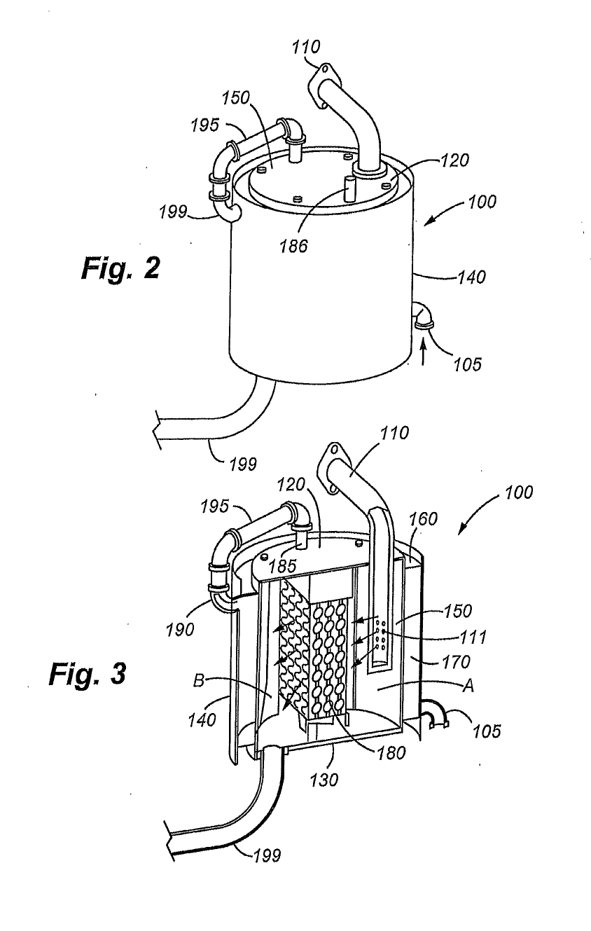

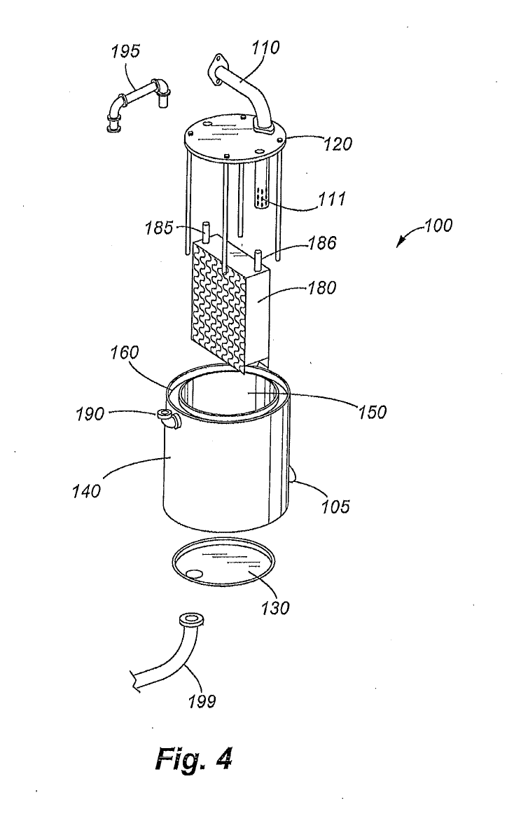

Referring to FIGS. 2-4, heated gases preferably generated by the heat generating unit 30 and/or other devices are supplied to a compact heat exchanger 100 through an exhaust gas inlet 110. The compact heat exchanger 100 is preferably cylindrical in shape (though other shapes could easily accommodate the inventive aspects of the disclosed device) with a preferably cylindrical top cover 120 and bottom cover 130. Two housings 140 and 150, also preferably cylindrical in shape are in a concentric arrangement such that the external housing 140 substantially encloses the internal housing 150. A ring 160 joins the external housing 140 and the internal housing 150 near the top and the base (not shown) of the internal housing 140 and external housing 150. As shown in FIG. 3, a water jacket 170 is created between the internal housing 140 and external housing 150 and rings 160. A primary heat exchanging device 180, such as a radiator, which can but need not be of a tube and fin type, lies within the internal housing 150. The top cover 120 and bottom cover 130 enclose the primary heat exchanging device, i.e. radiator, 180 within the internal housing 150, creating Chamber A and B. (See FIG. 3). Chambers A and B can be sealed, substantially sealed, or need not be sealed at all by the radiator.

In operation, fluid is supplied to inlet pipe 105, under pressure, filling water jacket 170. The fluid next travels via intermediate pipe 190 out of the water jacket 170, through conduit 195 and into radiator inlet 185. The fluid then travels through tubes of the primary heat exchanger device, or radiator 180, exiting radiator outlet 186, which ultimately supplies fluid to wand assembly 50. A portion of the heated fluid exiting the radiator outlet 186 may be diverted back to the fluid box 22.

Next, the heat generating unit 30 or other devices produce super heated gas which is supplied to exhaust gas inlet 110 and which then flow through openings 111 into Chamber A. Because the supplied gas is under pressure, it is forced from Chamber A, through primary heat exchanger device, or radiator 180 and into Chamber B, before exiting exhaust pipe 199. As the hot gas passes through primary heat exchanger device, or radiator 180, heat is transferred from the gas to the primary heat exchanger device's, or radiator's 180, tubes and fins. Next, that heat is transferred from the tubes and fins to fluid traveling through the tubes. It is through this process that the cleaning fluid is primarily heated to a desired temperature, typically a preheated temperature, but the fluid could also be heated to a fully heated temperature. A muffler (not shown) controls the output of noise during operation of the cleaning apparatus 10.

In one embodiment of the present invention, preheating first occurs by the transfer of heat from the hot exhaust gas to the inner wall of inner housing 150, and then from inner housing 150 to fluid circulating within water jacket 170. As will be appreciated to a skilled artisan, heat will transfer from the exhaust gases circulating within both Chambers A and B. Also, heat captured by the primary heat exchanger device, or radiator 180, is also available to transfer to the water jacket 170, either through contact with portions of internal housing 150 and/or top and bottom covers 120 and 130. In this way, more heat energy is captured by the present device than could be captured without use of the present sealed system.

In operation, the temperature of the fluid typically exiting the radiator outlet 186 is increased by approximately 15° to 20° F. at a through rate of five (5) gallons per minute. The temperature increase could be enhanced, including substantially increased, if the amount of fluid passing through the device per unit of time were decreased. Typically, one would desire to have a cleaning fluid exit the cleaning wand at a temperature exceeding 160° F. That temperature can be obtained, if the throughput of fluid is appropriately adjusted, using only the compact heat exchanger 100. However, to achieve faster throughput it is often desirable to utilize a second, primary heat exchanger 200.

Thus, in one preferred embodiment, a second or more heat exchangers 200 is used to further heat the heated fluid exiting the radiator outlet 186. The second heat exchanger 200 may be of a radiator type, which can but need not be of a tube and fin type, or a coil-type heat exchanger. Because additional temperature increase necessary for operation of the cleaning apparatus 10 at desired temperatures is diminished after preheating of the fluid occurs by use of the compact heat exchanger 100, the overall fuel consumption of the overall cleaning apparatus 10 is reduced, often considerably.

The design of the compact heat exchanger 100, which may preferably have a height of approximately 18 inches and a diameter of approximately 12 inches, preferably efficiently uses organically created super heated exhaust gases from the heat generating unit 30 to preheat the incoming fluid. In particular, the super heated exhaust gases are not only provided to the primary heat exchanger device, or radiator 180, but also are absorbed by the internal housing 150. Thus, as will be appreciated by those of skill in the art, only one heat source is needed to preheat the incoming supply of fluid to an initial heightened temperature through the water jacket 170, through exposure to the super heated exhaust gases provided to the primary heat exchanger device, or radiator 180. Accordingly, there is no need for other mechanisms, such as diversion of heated water or aggregation of secondary heat sources, to preheat the incoming fluid to a desired and constant temperature, which also contributes to a decreased fuel consumption of the overall cleaning apparatus 10.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is/are capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items as would be understood by those of skill in the art.

What is claimed is:

1. A heat exchanger for use in a cleaning device comprising:
a fluid jacket including a fluid inlet, a fluid outlet, an external housing and an internal housing having an internal surface and, wherein fluid entering the fluid jacket is in contact with at least a substantial portion of the internal surface of the internal housing;
a primary heat exchanging device having a fluid inlet and a fluid outlet and substantially enclosed by the internal housing and creating a first and second chamber within the internal housing, and having a fluid inlet connected to a fluid outlet of the fluid jacket;
an inlet for supplying heated gas to the first chamber; and
an outlet for removing gas from the second chamber after that gas has passed through at least one of or around the primary heat exchanging device through the radiator.

2. The heat exchanger of claim 1, wherein the fluid jacket is of one of an annular shape and an oval shape.

3. The heat exchanger of claim 1, wherein the external housing and internal housing is of one of a substantially cylindrical shape or an oval shape.

4. The heat exchanger of claim 1, wherein the heated gas is supplied by a heat generating unit.

5. The heat exchanger of claim 4, wherein the heat generating unit is an internal combustion engine.

6. The heat exchanger of claim 1, wherein the primary heat exchanging device includes tubes and fins.

7. The heat exchanger of claim 1, wherein the temperature of the fluid exiting the fluid outlet of the primary heat exchanging device fluid outlet is increased by at least approximately 15° F.

8. The heat exchanger of claim 1, further including a top and a bottom.

9. The heat exchanger of claim 8, further including a top which is formed in integral with a top ring and a bottom is formed integral with a bottom ring.

10. A system of applying a heated cleaning fluid to a surface, comprising:
a heat exchanger comprising;
a fluid jacket including a fluid inlet, a fluid outlet, an external housing and an internal housing having an internal surface and, wherein fluid entering the fluid jacket is in contact with at least a substantial portion of the internal surface of the internal housing;
a primary heat exchanging device having a fluid inlet and a fluid outlet and substantially enclosed by the internal housing and creating a first and second chamber within the internal housing, and having a fluid inlet connected to a fluid outlet of the fluid jacket;
an inlet for supplying heated gas to the first chamber; and
an outlet for removing gas from the second chamber after that gas has passed through at least one of or around the primary heat exchanging device through the radiator; and
wherein fluid is passed through the fluid jacket and outlet of the fluid jacket in a preheated condition, such that the temperature of the fluid in the fluid jacket is increased, and then passed through the fluid inlet of the radiator and exits the heat exchanger in a heated condition for further heating by a second heat exchanger.

11. The system of claim 10, wherein the fluid jacket is of an annular shape.

12. The system of claim 10, wherein the heated fluid is in communication with a wand.

13. The system of claim 10, wherein the heated gas is supplied by a heat generating unit.

14. The system of claim 13, wherein the heat generating unit is an internal combustion engine.

15. The system of claim 10, wherein the radiator includes tubes and fins.

16. The system of claim 10, wherein the temperature of the fluid exiting the fluid outlet of the primary heat exchanging device is increased by at least approximately 20° F.

17. The system of claim 10, wherein the temperature exiting the second heat exchanger is increased by approximately at least 140° F.

18. The system of claim 10, wherein the heat exchanger further includes a top and a bottom.

19. The system of claim 18, wherein the top which is formed integral with a top ring and a bottom is formed integral with the bottom ring.

20. The system of claim 10, wherein said fluid first flows from a water inlet into a fluid box.

21. The system of claim 10, further comprising a pump that facilitates the flow of the fluid through the system.

22. The system of claim 21, wherein the pump diverts a portion of the fluid exiting the fluid outlet of the primary heat exchanging device to the fluid box.
